(19) United States
(12) Patent Application Publication
(10) Pub. No.: US 2014/0102148 A1
(43) Pub. Date: Apr. 17, 2014

(54) System and Method for Splicing Optical Fibers in Order to Mitigate Polarization Dependent Splice Loss

(71) Applicant: Youichi Akasaka, Allen, TX (US)

(72) Inventor: Youichi Akasaka, Allen, TX (US)

(73) Assignee: Fujitsu Limited, Kanagawa (JP)

(21) Appl. No.: 13/649,599

(22) Filed: Oct. 11, 2012

(51) Int. Cl. G02B 6/255

(52) U.S. Cl. 65/407; 385/96

(57) ABSTRACT

In certain embodiment, a fiber fusion apparatus for mitigating polarization dependent splice loss include a first fiber guide operable to maintain alignment of a first optical fiber relative to a center axis and a second fiber guide operable to maintain alignment of a second optical fiber relative to the center axis. The apparatus further includes three or more electrodes evenly-spaced around the center axis. Each of the three or more electrodes is operable to apply heat to adjacent ends of the first and second optical fibers in order to fuse the first and second optical fibers.

### TECHNICAL FIELD

This invention relates generally to fiber optics and more particularly to a system and method for splicing optical fibers in order to mitigate polarization dependent splice loss.

### BACKGROUND OF THE INVENTION

Telecommunications systems, cable television systems, and other data communication networks often use optical networks to communicate information between endpoints. In an optical network, optical fibers function as waveguides such that information in the form of optical signals can be sent through the optical fibers. Because light propagates through optical fibers with little attenuation, optical fibers experience less loss with distance when compared to other transmission media (e.g., copper). As a result, optical networks are often used to communicate information over long distances. To cover these long distances, many optical fibers may need to be joined together. For example, the ends of two optical fibers may need to be cleaved and spliced together (e.g., mechanically joined or fused using heat).

### SUMMARY OF THE INVENTION

According to embodiments of the present disclosure, disadvantages and problems associated with previous systems for splicing optical fibers may be reduced or eliminated.

In certain embodiment, a fiber fusion apparatus for mitigating polarization dependent splice loss include a first fiber guide operable to maintain alignment of a first optical fiber relative to a center axis and a second fiber guide operable to maintain alignment of a second optical fiber relative to the center axis. The apparatus further includes three or more electrodes evenly-spaced around the center axis. Each of the three or more electrodes is operable to apply heat to adjacent ends of the first and second optical fibers in order to fuse the first and second optical fibers.

Certain embodiments of the present disclosure may provide one or more technical advantages. For example, polarization dependent loss (PDL) may result from misalignment of fiber cores at a fiber splice point in an optical network, and the amount of PDL may increase as the amount of misalignment increases. Accordingly, it is desirable to minimize fiber core misalignment when fusing optical fibers in order to mitigate PDL. Certain embodiments of the present disclosure include a fiber fusion apparatus that has three or more evenly-spaced electrodes. Accordingly, the heat applied to the optical fibers during fusion may be more evenly distributed than in certain conventional systems (e.g., system including only two electrodes). Because uneven heat distribution during the fusion process may cause core misalignment, the heat distribution provided by certain embodiments of the present disclosure may reduce core misalignment during the fusion process (thereby reducing PDL at the resulting splice point).

As another example, polarization dependent loss (PDL) may result from axis bending at fiber splice point in an optical network (i.e., the core of one fiber being oriented at a different angle than the core of the fiber to which it is fused). Accordingly, it is desirable to minimize axis bending when fusing optical fibers in order to mitigate PDL. As discussed above, certain embodiments of the present disclosure include a fiber fusion apparatus that has three or more evenly-spaced electrodes, and the heat applied by those three or more evenly-spaced electrodes may serve to “force” the fiber cores being fused into angular alignment (thereby reducing or eliminating axis bending at the splice point and reducing PDL).

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example optical network 100, according to certain embodiments of the present disclosure;

FIGS. 2A-2B illustrate the polarization dependent loss on signals traveling through an optical network as a result of fiber splices;

FIGS. 3A-3B illustrate detailed views of an example system for splicing two optical fibers to create a fiber splice, according to certain embodiments of the present disclosure; and

FIGS. 4A-4B illustrate detailed views of an alternative example system for splicing two optical fibers to create a fiber splice, according to certain embodiments of the present disclosure.

### DETAILED DESCRIPTION OF THE DRAWINGS

FIG. 1 illustrates an example optical network 100, according to certain embodiments of the present disclosure. Optical network 100 may include a plurality of optical fibers 102 extending between various network elements and configured to transport one or more optical signals communicated by certain of those network elements. In certain embodiments, multiple optical fibers 102 may be joined at one or more fiber splices 104 in order span the distance between any two network elements. The network elements of optical network 100 may include one or more transmitters 106, one or more multiplexers (MUX) 108, one or more amplifiers 110, one or more optical add/drop multiplexers (OADM) 112, one or more demultiplexers 114, and one or more receivers 116. Although a particular implementation of optical network 100 having a particular arrangement of network elements is illustrated and primarily described, the present invention contemplates any suitable implementation of optical network 100 having any suitable arrangement of network elements, according to particular needs.

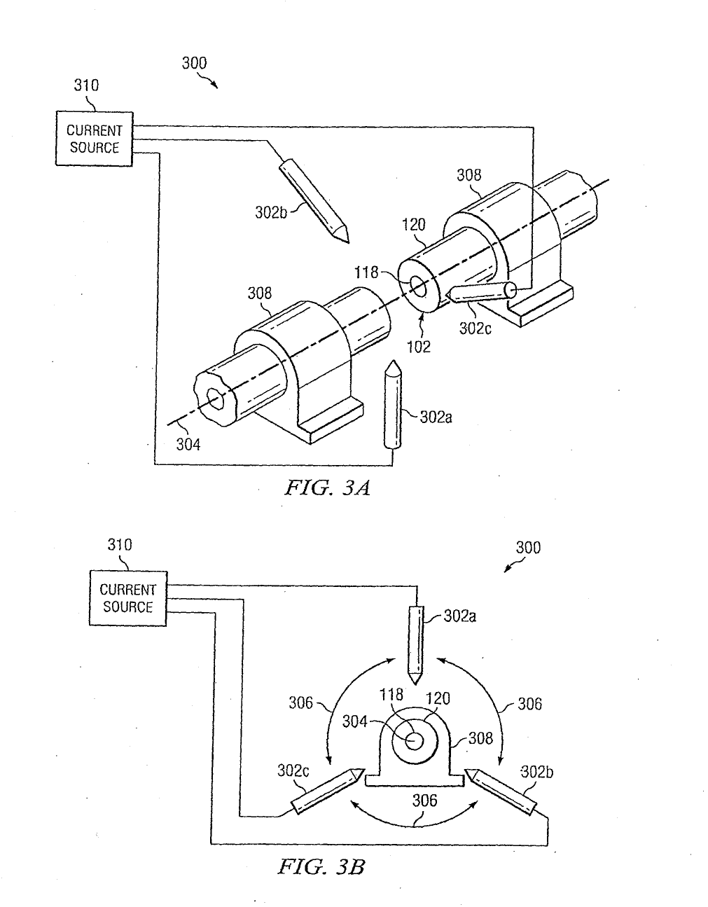

Optical network 100 may comprise a point-to-point optical network with terminal nodes, a ring optical network, a mesh optical network, or any other suitable optical network or combination of optical networks. The optical fibers 102 deployed in optical network 100 may each comprise any suitable strand of glass that acts as waveguide such that an optical signal (or any other suitable signal) may be communicated between the various network elements of optical network 100. In certain embodiments, each optical fiber 102 may have one or more fiber cores (e.g., fiber core 118, as discussed with regard to FIGS. 3A-3B, below) surrounded by cladding (e.g., cladding 120 as discussed with regard to FIGS. 3A-3B, below). Example optical fibers 102 include Single-Mode Fibers (SMF), Enhanced Large Effective Area Fibers (ELEAF), TrueWave® Reduced Slope (TW-RS) fibers, or any other suitable fiber, according to particular needs.

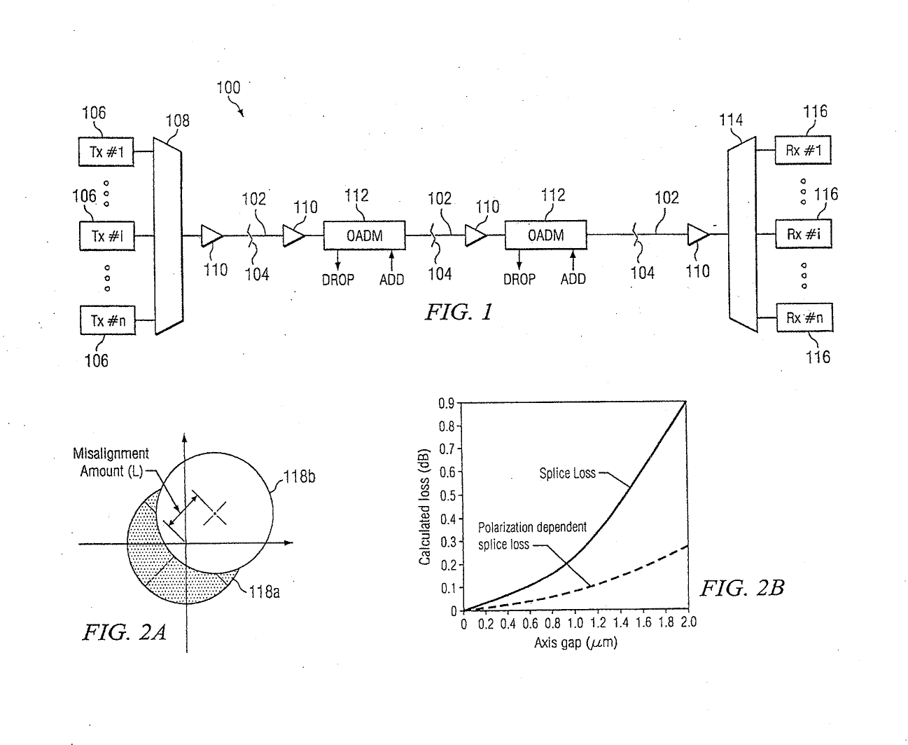

Because the distance between any two network elements may be greater than the length of a single optical fiber 102, optical network 100 may include a number of fiber splices 104. Each fiber splice 104 may comprise any suitable junction between adjacent optical fibers. For example, each fiber splice 104 may comprise a point at with the glass core of one optical fiber 102 has been fused (e.g., by the application of heat) to the glass core of another optical fiber 102 (as discussed in further detail below with regard to FIG. 2).

Optical network 100 may include devices configured to transmit optical signals over fibers 102. Information may be transmitted and received through optical network 100 by modulation of one or more wavelengths of light to encode the information on the wavelength. In optical networking, a wavelength of light may also be referred to as a channel. Each channel may be configured to carry a certain amount of information through optical network 100.

To increase the information carrying capabilities of optical network 100, multiple signals transmitted at multiple channels may be combined into a single optical signal. The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in optical networks may be limited to the bit-rate of solely one wavelength. With more bandwidth, optical networks are capable of transmitting greater amounts of information. Optical network 100 may be configured to transmit disparate channels using WDM, DWDM, or some other suitable multi-channel multiplexing technique, and to amplify the multi-channel signal.

Optical network 100 may include one or more optical transmitters (Tx) 106 configured to transmit optical signals through optical network 100 in specific wavelengths or channels. Transmitters 106 may comprise any system, apparatus or device configured to convert an electrical signal into an optical signal and transmit the optical signal. For example, transmitters 106 may each comprise a laser and a modulator configured to receive electrical signals and modulate the information contained in the electrical signals onto a beam of light produced by the laser at a particular wavelength and transmit the beam carrying the signal throughout the network.

Multiplexer 108 may be coupled to transmitters 102 and may be any system, apparatus or device configured to combine the signals transmitted by transmitters 106, in individual wavelengths, into a single WDM or DWDM signal.

Amplifiers 110 may amplify the multi-channeled signals within network 100. Amplifiers 110 may be positioned before and/or after certain lengths of optical fiber 102. Amplifiers 110 may comprise any system, apparatus, or device configured to amplify signals. For example, amplifiers 110 may comprise an optical repeater that amplifies the optical signal. This amplification may be performed with opto-electrical or electro-optical conversion. In certain embodiments, amplifiers 110 may comprise an optical fiber doped with a rare-earth element. When a signal passes through the fiber, external energy may be applied to excite the atoms of the doped portion of the optical fiber, which increases the intensity of the optical signal. As an example, amplifiers 110 may comprise an erbium-doped fiber amplifier (EDFA). However, any other suitable amplifier, such as a semiconductor optical amplifier (SOA), may be used.

Optical network 100 may additionally include OADMs 112 coupled to one or more optical fibers 102. OADMs 112 may comprise an add/drop module, which may include any system, apparatus or device configured to add and/or drop optical signals from fibers 102. After passing through an OADM 112, a signal may travel along optical fibers 102 directly to a destination, or the signal may be passed through one or more additional OADMs 112 before reaching a destination.

Network 100 may additionally include one or more demultiplexers 114 at one or more destinations of network 100. A demultiplexer 114 may comprise any system apparatus or device that may act as a demultiplexer by splitting a single WDM signal into its individual channels. In some embodiments, a demultiplexer 114 may comprise a multiplexer 104 but configured to split WDM signals into their individual channels instead of combine individual channels into one WDM signal. For example, network 100 may transmit and carry a forty channel DWDM signal. Demultiplexer 114 may divide the single, forty channel DWDM signal into forty separate signals according to the forty different channels.

Network 100 may additionally include receivers 116 coupled to demultiplexer 114. Each receiver 116 may be configured to receive signals transmitted in a particular wavelength or channel, and process the signals for the information that they contain. Accordingly, network 100 may include at least one receiver 116 for every channel of the network.

Although a particular implementation of network 100 is illustrated and primarily described, the present disclosure contemplates any suitable implementation of network 100, according to particular needs. Moreover, although various components of network 100 have been depicted as being located at particular positions within network 100, the present disclosure contemplates those components being positioned at any suitable location, according to particular needs.

FIGS. 2A-2B illustrate the polarization dependent loss on signals traveling through optical network 100 as a result of fiber splices 104. As discussed above with regard to FIG. 1, the amount of information that may be transmitted over optical network 100 may vary with the number of optical channels coded with information and multiplexed into one signal. Accordingly, an optical signal employing WDM may carry more information than an optical signal carrying information over solely one channel. An optical signal employing DWDM may carry even more information. Besides the number of channels carried, another factor that affects how much information can be transmitted over an optical network may be the bit rate of transmission. The greater the bit rate, the more information may be transmitted.

Polarization division multiplexing (PDM) technology may enable achieving a greater bit rate for information transmission. PDM transmission comprises modulating information onto various polarization components of an optical signal associated with a channel. The polarization of an optical signal may refer to the direction of the oscillations of the optical signal. The term “polarization” may generally refer to the path traced out by the tip of the electric field vector at a point in space, which is perpendicular to the propagation direction of the optical signal. The term “linear polarization” may generally refer to a single direction of the orientation of the electric field vector. Generally, an arbitrary linearly polarized wave can be resolved into two independent orthogonal components labeled x and y, which are in phase with each other. For example, in polarization multiplexed transmission, an optical beam created by a laser may be highly linearly polarized. The beam may be divided by a polarization beam splitter according to the x-polarization component of the beam and the y-polarization component of the beam. Upon being split, the x-polarization component may be aligned with a horizontal axis and the y-polarization component may be aligned with a vertical axis of the beam. It is understood that the terms “horizontal” polarization and “vertical” polarization are merely used to denote a frame of reference for descriptive purposes, and do not relate to any particular polarization orientation.

Following splitting of the beam into the x and y polarization components, information may be modulated onto both beams. Following modulation, both beams may be combined by a polarization beam combiner such that the combined beam comprises an optical signal with two polarization components (e.g., an x-polarization component and a y-polarization component) with information modulated onto each polarization component. Accordingly, by modulating information onto both the y-polarization component and x-polarization component of the signal, the amount of information that may be carried by the channel associated with the signal over any given time may increase (e.g., increasing the bit rate of the channel).

In certain embodiments, fiber splices 104 may affect the modulated x and y polarization components of each channel associated with an optical signal. Misalignment of optical fiber core 202a and optical fiber core 202b at a fiber splice 104 may result in attenuation and/or amplification of the various polarization components of each channel within the optical signals, thus causing a polarization dependent loss (PDL) and/or a polarization dependent gain (PDG). Although the polarization dependent effects of a fiber splice 104 may result from both PDL and PDG, the overall result of the effects may be referred to simply as PDL.

For example, core misalignment at a fiber splice 104 may attenuate the modulated y-polarization of a wavelength associated with a channel greater than it may attenuate the modulated x-polarization of the same wavelength. Additionally, the modulated x and y polarizations of one wavelength associated with one channel may be affected differently than the x and y polarization of another wavelength associated with a different channel. Similarly, core misalignment at a fiber splice 104 may amplify the modulated x and y polarization components of each channel associated with the optical signals differently. Accordingly, in a multi-polarization WDM signal, each modulated polarization component of each channel may experience varying degrees of gain and loss while passing through an optical network. These varying degrees of gain and loss may cause signal distortion and loss of information (which may be represented in decibels (dB)).

One particular example of the PDL resulting from misalignment of one fiber core 118a and another fiber core 118b at a splice 104 is graphically illustrated in FIG. 2B. FIG. 2B plots the PDL (in dB) versus the amount of fiber misalignment L (as represented in FIG. 2A). As is clearly illustrated, the amount of PDL increases as the misalignment L between fiber core 202a and fiber core 202b increases. Accordingly, it is desirable to minimize the amount of misalignment at a fiber splice 104 in order to minimize the amount of PDL resulting from that fiber splice 104.

FIGS. 3A-3B illustrate an example fiber splicing apparatus 300 for splicing two optical fibers 102 to create a fiber splice 104, according to certain embodiments of the present disclosure. Each optical fiber 102 may include a fiber core 118 surrounded by fiber cladding 120. In order to splice adjacent fibers 102 to generate a fiber splice 104, the fiber core 118 of each fiber may be fused together. Although apparatus 300 is depicted and described as splicing optical fibers 102 as having a single core 118, the present disclosure contemplates apparatus 300 being used to splice optical fibers 102 having any suitable number of cores 118.

Fiber splicing apparatus 300 may include a number of electrodes 302 distributed about a center axis 304. The electrodes 302 may be located in a plane that is substantially perpendicular to center axis 304, and the electrodes 302 may be evenly distributed around center axis 304. For example, in the illustrated embodiments, three electrodes 302a-c may be distributed around center axis 304 such that the angle 306 between any two adjacent electrodes is approximately 120 degrees.

Fiber splicing apparatus 300 may additionally include fiber guides 308 operable to maintain alignment of fiber cores 118 along center axis 304. Fiber guides may include any suitable device operable to hold a fiber 102 in place. In certain embodiments, fiber guides 308 may be manually adjustable such that a user of apparatus 300 may adjust the alignment of the two fiber cores (e.g., by visual inspection). In certain other embodiments, fiber guides 308 may be automatically adjusted in response to an alignment monitoring system (not depicted) operable to measure the alignment of the fiber cores 118. For example, fiber cores 118 may be automatically aligned using an optical core alignment technique (also known as profile alignment) in which the two optical fibers 118 are illuminated from two directions (approximately ninety degrees apart) and the fiber guides 308 are adjusted automatically based on images generated by video cameras opposite the light sources. As another example, fiber cores 118 may be automatically aligned using a Local Injection and Detection (LID) technique, or any other suitable alignment technique.

Once fiber cores 118 are aligned and oriented adjacent to one another (e.g., using fiber guides 118), the optical fibers 102 may be fused together. In certain embodiments, optical fibers 118 may be prepared for fusion by stripping cladding 120 and cleaving the end of the fiber core 118 prior to being oriented as described above. In certain embodiments, the separation point between the two cores 118 may be coplanar with electrodes 302 such that fiber cores 118 may be fused together at the separation point.

Fiber cores 118 may be fused together using heat applied by electrodes 302 (as described in further detail below). Electrodes 302 may comprise any suitable device operable to apply heat to adjacent fiber cores 118 in order to fuse the fiber cores 118. For example, electrodes 302 may each be operable to receive an electrical current from a current source 310. Upon receipt of the electrical current, an electric arc may be formed by electrodes 302. The electric arc may heat the fiber cores 118 to their melting point, resulting in the fiber cores 118 being fused together. In certain embodiments, a relatively small electric current may be supplied to electrodes 302 prior to fusion, the relatively small electric current causing an electric arc that serves to clean any debris of the ends of fiber cores 118 prior to fusion.

Although electrodes are depicted and primarily described as receiving a current from a current source 310 in order to apply heat to fiber cores 118, the present disclosure contemplates electrodes 302 applying heat to cores 118 in any suitable manner (e.g., by generating a flame by combusting gas from a fuel source).

Because fiber splicing apparatus 300 includes three evenly-spaced electrodes 302a-c, the electrodes 302a-c may more evenly distribute the heat applied to the adjacent fiber cores 118 during fusion (as compared to certain conventional systems including only two electrodes). Accordingly, fiber splicing apparatus 300 may reduce misalignment of fiber cores 118 resulting from the fusion process (as uneven heat distribution during the fusion process may cause core misalignment), thereby reducing PDL (as core misalignment at a fiber splice 104 may cause PDL, as discussed above with regard to FIGS. 2A-2B).

In addition to core misalignment, PDL may result from axis bending at a fiber splice 104 (i.e., when one fiber core 118 is oriented at a different angle than the fiber core 118 to which it is fused). Because the electrodes 302a-c of fiber splicing apparatus 300 may more evenly distribute the heat applied to the adjacent fiber cores 118 during fusion (as discussed above), fiber splicing apparatus 300 may serve to “force” the fiber cores 118 into angular alignment. As a result, fiber splicing apparatus 300 may additionally reduce PDL resulting from axis bending at the resulting fiber splice 104.

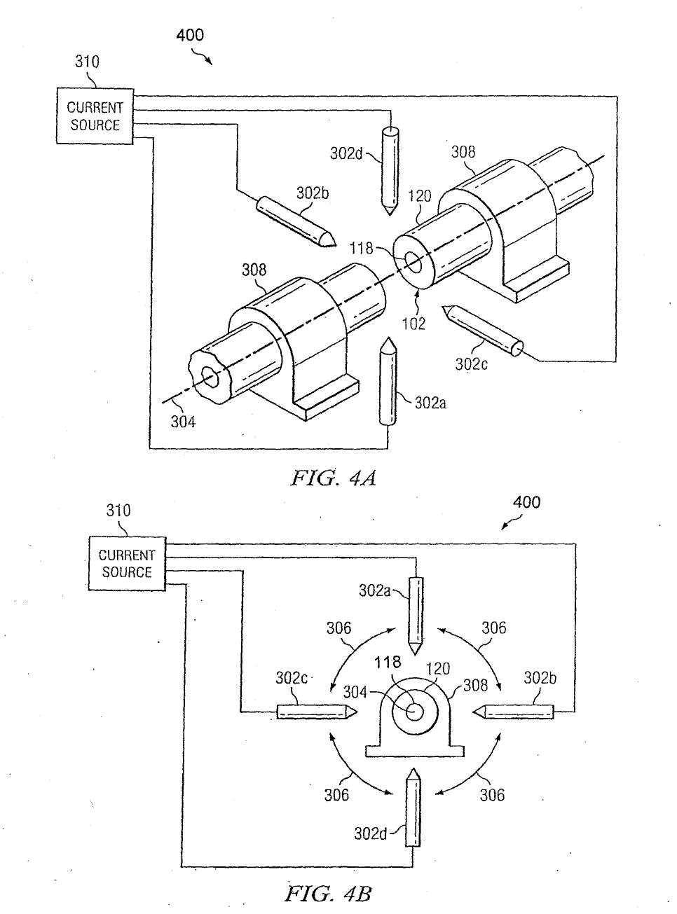

FIGS. 4A-4B illustrate an example alternative fiber splicing apparatus 400 for splicing two optical fibers 102 to create a fiber splice 104, according to certain embodiments of the present disclosure. In the depicted alternative embodiment, apparatus 400 comprises four electrodes 302a-d distributed around center axis 304 such that the angle 306 between any two adjacent electrodes is approximately 90 degrees.

Like the three electrodes 302a-c of fiber splicing apparatus 300, the four electrodes 302a-d of fiber splicing apparatus 400 may more evenly distribute the heat applied to the adjacent fiber cores 118 during fusion (as compared to certain conventional systems including only two electrodes). As a result, fiber splicing apparatus 400 may reduce PDL at a fiber splice 102 (for substantially the same reasons as described above with regard to FIGS. 3A-3B)

Although example embodiments including three and four evenly-spaced electrodes have been depicted and described, the present disclosure contemplates and suitable number of evenly-spaced electrodes 302, according to particular needs. Because certain embodiment of the present disclosure include three or more evenly spaced electrodes 302, better alignment of the cores 118 of fibers 102 being fused may be achieved (as compared to certain conventional splicing techniques using only two electrodes. Accordingly, certain embodiments of the present disclosure may mitigate PDL resulting from fiber splices 104.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A fiber fusion apparatus, comprising:
a first fiber guide operable to maintain alignment of a first optical fiber relative to a center axis;
a second fiber guide operable to maintain alignment of a second optical fiber relative to the center axis; and
three or more electrodes evenly-spaced around the center axis, each of the three or more electrodes being operable to apply heat to adjacent ends of the first and second optical fibers in order to fuse the first and second optical fibers.

2. The apparatus of claim 1, wherein the three or more electrodes are each located in a plane that is substantially perpendicular to the center axis.

3. The apparatus of claim 1, wherein:
the three or more electrodes comprises three electrodes; and
the three electrodes are evenly spaced around the center axis such that adjacent ones of the three electrodes are separated by approximately one-hundred twenty degrees.

4. The apparatus of claim 1, wherein:
the three or more electrodes comprises four electrodes; and
the four electrodes are evenly spaced around the center axis such that adjacent ones of the four electrodes are separated by approximately ninety degrees.

5. The apparatus of claim 1, further comprising a current source operable to supply a current to each of the three or more electrodes, the supplied current resulting in an electrical arc that applies the heat to the adjacent ends of the first and second optical fibers.

6. The apparatus of claim 1, where the first optical fiber and the second optical fiber are each single core optical fibers.

7. The apparatus of claim 1, where the first optical fiber and the second optical fiber are each multi-core optical fibers.

8. A method, comprising:
aligning a first optical fiber relative to a center axis using a first fiber guide;
aligning a second optical fiber relative to the center axis using a second fiber guide; and
applying heat to adjacent ends of the first and second optical fibers using three or more electrodes evenly-spaced around the center axis, the application of heat resulting in the fusion of first and second optical fibers.

9. The method of claim 8, wherein the three or more electrodes are each located in a plane that is substantially perpendicular to the center axis.

10. The method of claim 8, wherein:
the three or more electrodes comprises three electrodes; and
the three electrodes are evenly spaced around the center axis such that adjacent ones of the four electrodes are separated by approximately one-hundred twenty degrees.

11. The method of claim 8, wherein:
the three or more electrodes comprises four electrodes; and
the four electrodes are evenly spaced around the center axis such that adjacent ones of the three electrodes are separated by approximately ninety degrees.

12. The method of claim 8, wherein each of the three or more electrodes are supplied with current by a current source, the supplied current resulting in an electrical arc that applies the heat to the adjacent ends of the first and second optical fibers.

13. The method of claim 8, where the first optical fiber and the second optical fiber are each single core optical fibers.

14. The method of claim 8, where the first optical fiber and the second optical fiber are each multi-core optical fibers.

15. A fiber fusion apparatus, comprising:
a first fiber guide operable to maintain alignment of a first optical fiber relative to a center axis;
a second fiber guide operable to maintain alignment of a second optical fiber relative to the center axis; and
three or more electrodes evenly-spaced around the center axis and located in a plane substantially perpendicular to the center axis;
a current source operable to supply a current to each of the three or more electrodes, the supplied current resulting in an electrical arc that applies heat to adjacent ends of the first and second optical fibers in order to fuse the first and second optical fibers.

16. The apparatus of claim 15, wherein:
the three or more electrodes comprises three electrodes; and
the three electrodes are evenly spaced around the center axis such that adjacent ones of the three electrodes are separated by approximately one-hundred twenty degrees.

17. The apparatus of claim 15, wherein:
the three or more electrodes comprises four electrodes; and
the four electrodes are evenly spaced around the center axis such that adjacent ones of the four electrodes are separated by approximately ninety degrees.

18. The apparatus of claim 15, where the first optical fiber and the second optical fiber are each single core optical fibers.

19. The apparatus of claim 15, where the first optical fiber and the second optical fiber are each multi-core optical fibers.
